(19) United States
(12) Patent Application Publication
(10) Pub. No.: US 2004/0183991 A1
(43) Pub. Date: Sep. 23, 2004

(54) Liquid crystal display panel and method for manufacturing the same

(75) Inventor: Chen Lung Kuo, Tainan Science-Based Industrial Park (TW)

Correspondence Address: Finnegan, Henderson, Farabow,, Garrett & Dunner, L.L.P., 1300 I Street, N.W., Washington, DC, 20005-3315, US

(73) Assignee: Chi Mei Optoelectronics Corp.

(21) Appl. No.: 10/779,736

(22) Filed: Feb. 18, 2004

(30) Foreign Application Priority Data
Mar. 18, 2003 (TW) 092106124

(51) Int. Cl. G02F 1/1339

(52) U.S. Cl. 349/155

(57) ABSTRACT

A liquid crystal display panel mainly includes a first substrate, a second substrate, a liquid crystal layer sandwiched between the first and the second substrates, and a plurality of first protrusion disposed on the first substrate for maintaining a first cell gap between the first and second substrates. The present invention is characterized by having a plurality of second protrusions disposed on the first substrate for maintaining a second cell gap smaller than the first cell gap when the liquid crystal display panel is subjected to an external force. But when the liquid crystal display panel isn't subjected to any external force, the second protrusion is separated from the second substrate by a distance. The present invention further provides a method for manufacturing the liquid crystal display panel.

### BACKGROUND OF THE INVENTION

1. Field of the Invention

The present invention relates to a liquid crystal display (LCD) panel and a manufacturing method thereof, and more particularly to a liquid crystal display panel manufactured by one drop fill process and a manufacturing method thereof.

2. Description of the Related Art

As shown in FIGS. 1a and 1b, conventional liquid crystal display panels 100a and 100b respectively include a substrate 102 (i.e., a color filter substrate) and a substrate 104 (i.e., a thin film transistor substrate) which are disposed to face each other, and a liquid crystal layer 106 sandwiched between the substrates 102 and 104. Besides, a plurality of spacers 108 are provided between the substrates 102 and 104 to maintain a gap of a predetermined size between the two substrates.

In the manufacturing process of the liquid crystal display panels, the two substrates are assembled into a cell with only one injection opening by a seal material. Then a liquid crystal material is injected into the small space within the cell consisting of the two substrates. At last, the injection opening in the cell is sealed. The spacers for maintaining a precise cell gap (between 4-10 μm) between the two substrates are disposed on one of the substrates before the two substrates are assembled. Then the substrates are aligned and the seal material is cured. After the assembling process is completed, the liquid crystal material is injected into the gap maintained by the spacers. Next, the periphery of the substrates is pressed until the gap between the substrates reaches the predetermined size. After excess liquid crystal material is wiped from the edge of the cell, a sealant (e.g., epoxy) is applied and then cured to seal the injection opening.

In the aforementioned method, the injection quantity of the liquid crystal material doesn't need to be controlled precisely, because the excess liquid crystal material can be drained out through the injection opening in the pressing step and then wiped from the cell.

However, in a newly proposed technique based on a one drop fill (abbreviated ODF) method disclosed in U.S. Pat. No. 5,263,888 to Ishihara et al., one of the substrates receives droplets of liquid crystal material prior to joining it with the other substrate. This greatly reduces the number of the manufacturing steps and increases the manufacturing efficiency. However, since the liquid crystal material is dropped prior to the step of sealing the two substrates, the quantity of the liquid crystal material must be controlled precisely. A shortage of the quantity of the LC material in the LCD panel results in so-called voids observed in the LCD cell. Gravity mura can be observed in a LCD panel with an uneven cell gap due to excessive LC material.

Fortunately, the substrates which form the LCD panel are slightly elastic. When the liquid crystal injection quantity is slightly less than the predetermined volume of the LCD cell, the external pressure will cause the substrates to be slightly bent such that the liquid crystal material completely fills the cell and no void is observed in the cell. However, the bending degree of the substrates is decided by the density of the spacers distributed in the liquid crystal display panel. The liquid crystal display panel 100a shown in FIG. 1a is provided with spacers in a lower density, and the liquid crystal display panel 100b shown in FIG. 1b is provided with spacers disposed in a higher density. FIG. 2 is a diagram illustrating the relationship between the liquid crystal injection quantity and the cell gap. Referring to FIG. 2, since the substrates of the liquid crystal display panel 100a can be bent to a larger degree due to the lower-density distribution of the spacers therein, the void is not observed in the liquid crystal display panel 100a unless the liquid crystal injection quantity is less than “a”, and the Gravity mura is not observed unless the liquid crystal injection quantity is more than “d”. Namely, the process window of the panel 100a is between “a” and “d”. In contrast, the substrates of the liquid crystal display panel 100b can only be bent to a less degree due to the higher-density distribution of the spacers therein, the void is observed in the liquid crystal display panel 100b if the liquid crystal injection quantity is less than “b”, and the Gravity mura is observed if the liquid crystal injection quantity is more than “c”. Namely, the process window of the panel 100b is between “b” and “c” which is apparently smaller than the process window of the panel 100a. Therefore, a liquid crystal display panel adopting a relative low-density spacer design will have a relative larger process window.

However, a liquid crystal display panel with relative low-density spacers is susceptible to deformation of the substrates thereof when it is subjected to an external force during subsequent laminating process, vacuum sucking process, etc., because of fewer supporting points therein; therefore, it is more likely that gravity mura or fracture is observed in such kind of liquid crystal display panel.

### SUMMARY OF THE INVENTION

Therefore, it is an object of the invention to provide a liquid crystal display panel having a plurality of first protrusions for maintaining a first cell gap between the substrates, and a plurality of second protrusions for maintaining a second cell gap which is smaller than the first cell gap between the substrates when the liquid crystal display panel is subjected to an external force thereby overcomes or at least reduces the above-mentioned limitations and problems of the prior art.

The liquid crystal display panel according to the present invention mainly comprises a first substrate, a second substrate, a liquid crystal layer sandwiched between the first and the second substrates and a plurality of first protrusion disposed on the first substrate. The first protrusions are separated from the second substrate by a first distance which preferably approximates zero. The first protrusions are adapted for maintaining a first cell gap between the substrates; therefore, they are generally designated as “spacers”.

The present invention is characterized in that the liquid crystal display panel further includes a plurality of second protrusions formed on the first substrate. The second protrusions are separated from the second substrate by a second distance different from the first distance. The difference between the second distance and the first distance ranges from about 0.2 μm to about 2.5 μm, preferably from about 1 μm to about 2 μm. The second protrusion is adapted for maintaining a second cell gap which is smaller than the first cell gap between the first and second substrates when the liquid crystal display panel is subjected to an external force.

The liquid crystal display panel of the present invention is preferably used in a multi-domain vertically aligned liquid crystal display device. Therefore, the liquid crystal display panel may further includes a plurality of third protrusions disposed on one of the first substrate and the second substrate for regulating orientation of the liquid crystal layer.

It is preferred that the first protrusions and the second protrusions are made of the same material, and the third protrusions are made of a different material. The first and second protrusions have a pillar shape.

The liquid crystal display panel of the present invention is one component of a liquid crystal display device. When the liquid crystal display panel is subjected to an external force during the subsequent processes of the liquid crystal display device, the first and second protrusions contact the second substrate and provide a better support for the liquid crystal display panel, but the third protrusions don't contact opposing substrate (the first substrate or the second substrate).

The present invention further provides a method for manufacturing the liquid crystal display panel. First, a plurality of first and second protrusions are formed from a first material on a first substrate. Preferably, the first protrusions and the second protrusion are formed simultaneously. A plurality of third protrusions are formed from a second material on one of the first and second substrates. Besides, a sealing member is formed on at least one of the first and second substrates. Then, at least one drop of a liquid crystal material is formed on one of the first and second substrates. One of the first and second substrates is superposed upon the other substrate. At last, a curing process of the sealing member is conducted thereby obtaining the liquid crystal display panel.

The present invention provides a liquid crystal display panel with relative low-density spacers (the aforementioned first protrusions). Therefore, when an one drop fill process is used to manufacture the liquid crystal display panel, the substrates constituting liquid crystal display panel can be bent to a larger degree thereby obtaining a larger process window in the liquid crystal injection process. When the liquid crystal display panel is subjected to an external force during subsequent LCD manufacturing processes (e.g., laminating process or vacuum sucking process), the second protrusions can also support the substrates of the liquid crystal display panel thereby preventing the liquid crystal display panel from being deformed too much that may cause Gravity mura or fracture. Therefore, in the present invention, a larger process window in the liquid crystal injection process is achieved and the obtained liquid crystal display panel has a good mechanical strength.

Other objects, advantages, and novel features of the invention will become more apparent from the following detailed description when taken in conjunction with the accompanying drawings.

### BRIEF DESCRIPTION OF THE DRAWINGS

FIG. 1a is a cross-section view of a portion of a conventional liquid crystal display panel with relative low-density spacers;

FIG. 1b is a cross-section view of a portion of another conventional liquid crystal display panel with relative high-density spacers;

FIG. 2 is a diagram illustrating the relationship between the liquid crystal injection quantity and the cell gap;

FIG. 3 is a cross-section view of a portion of a liquid crystal display panel according to one embodiment of the present invention;

FIG. 4 is a cross-section view of a portion of a liquid crystal display panel according to another embodiment of the present invention; and

FIG. 5 is a top plan view of a portion of the liquid crystal display panel of FIG. 4.

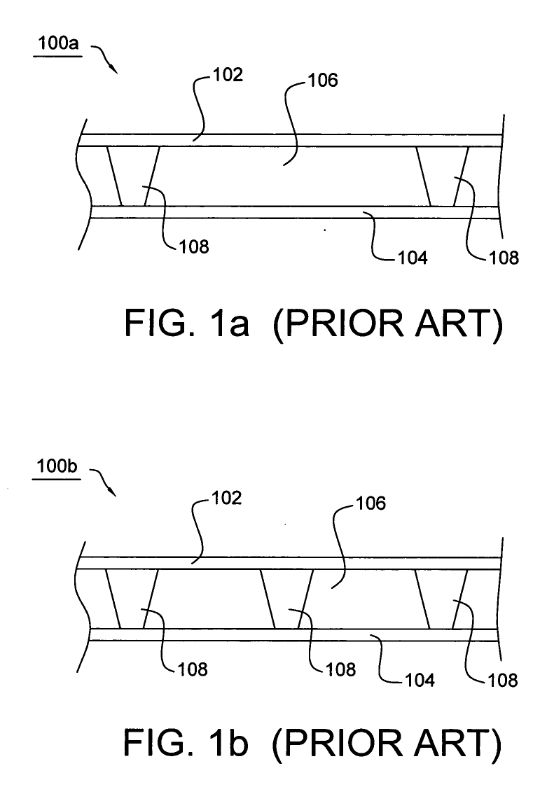

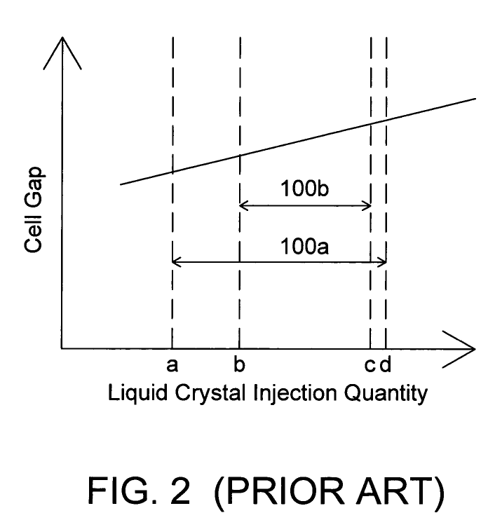

### DETAILED DESCRIPTION OF THE PREFERRED EMBODIMENT

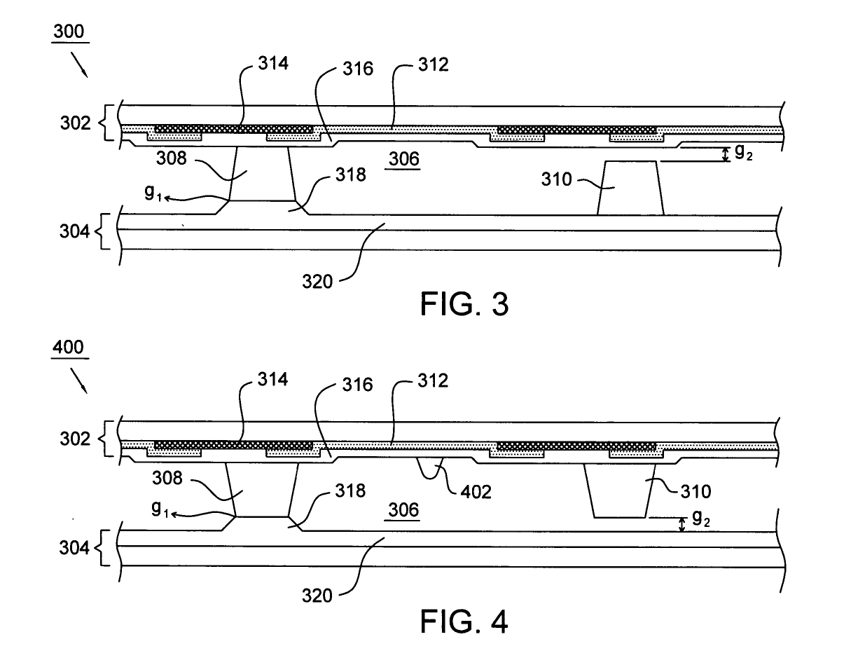

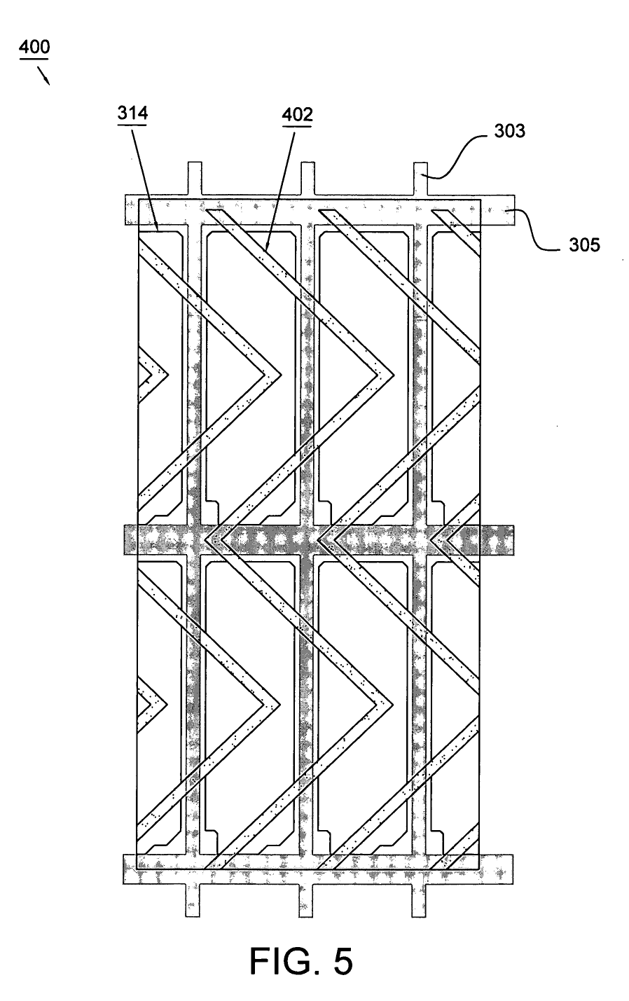

FIG. 3 illustrates a liquid crystal display panel 300 according to one embodiment of the present invention. The liquid crystal display panel 300 includes a substrate 302, a substrate 304, a liquid crystal layer 306 sandwiched between the substrates 302 and 304, and a plurality of protrusions 308 and 310 disposed on the substrate 304. The substrate 302 is a color filter substrate including a plurality of colored portion 312 formed thereon, a light-shielding matrix 314 between adjacent colored portions 312 and a counter electrode 316 formed over substantially the entire surface of the substrate 302. The substrate 304 is a thin film transistor substrate including a plurality of parallel data lines 303 (See FIG. 5), a plurality of parallel gate lines 305 (See FIG. 5), thin film transistors (TFTs) 318 disposed at each of the intersections of the data lines 303 and the gate line 305, and pixel electrodes (not shown) each disposed within a region defined by two adjacent data lines 303 and two adjacent gate lines 305 and corresponding to one colored portion 312 of the substrate 302. In the embodiment shown in FIG. 3, the protrusions 308, 310 are disposed on the substrate 304; however, the protrusions 308, 310 can also be disposed on the substrate 302 as shown in FIG. 4.

The protrusions 308 are used to maintain a substantially constant cell gap between the substrates 302 and 304, and they are generally designated as “spacers”. As shown in FIG. 3, the distance g₁ between the protrusions 308 and the substrate 302 approximates zero. When the liquid crystal display panel isn't subjected to any external force, the protrusions 310 are separated from the substrate 302 by a distance g₂ larger than the distance g₁. Preferably, the difference between the distance g₁ and the distance g₂ ranges from about 0.2 μm to about 2.5 μm, more preferably from about 1 μm to about 2 μm.

The protrusions 310 are designed for supporting the substrates 302 and 304 when the liquid crystal display panel is subjected to an external force such that the substrates 302 and 304 are slightly deformed. The protrusions 310 can maintain another substantially constant cell gap between the substrates 302 and 304 thereby increasing the supporting sites within the liquid crystal display panel 300 and increasing the mechanical strength and the anti-deformability of the panel 300.

The liquid crystal display panel of the present invention can also be used in a multi-domain vertically aligned liquid crystal display device. Referring to FIGS. 4 and 5, the protrusions 308 and 310 of the liquid crystal display panel 400 are disposed on the substrate 302, and the panel 400 further includes protrusions 402 for regulating orientation of the liquid crystal molecules in the liquid crystal layer 306 such that the liquid crystal molecules are aligned obliquely when a voltage is applied so that the orientation will include a plurality of directions within each pixel thereby improving viewing angle performance of the the liquid crystal display panel 400. Referring to FIG. 5, the protrusions 402 are arranged in parallel to one another on the substrate 302. Each protrusion 402 has a main body being bent substantially in a zigzag pattern. Referring to FIG. 4, the protrusions 402 need to be separated from the substrate 304 by a relative large distance for regulating orientation of the liquid crystal molecules. When the liquid crystal display panel 400 is subjected to an external force, the protrusions 402 will not contact the substrate 304 because of the relative larger cell gap maintained between the substrates 302 and 304 by the protrusions 402.

The protrusions 308 and 310 are used for supporting the substrates 302 and 304 in the present invention; therefore, the protrusions 308 and 310 preferably are made of the same material and have a pillar shape. Besides, the protrusions 402 are used for regulating orientation of the liquid crystal molecules in the liquid crystal layer 306; therefore, the protrusions generally are made of a material different from that of the protrusions 308 and 310 and have a main body being bent substantially in a zigzag pattern. Preferably, the protrusions 308 and 310 are harder than the protrusions 402 thereby providing a rigid support for the liquid crystal display panel.

The present invention further provides a method for manufacturing the liquid crystal display panel which will be described in conjunction with FIG. 4. First, a plurality of protrusions 308 and 310 are formed from a first material on the substrate 302. Preferably, the first protrusions and the second protrusions are formed simultaneously in order to reduces the number of the manufacturing steps. A plurality of protrusions 402 are formed from a second material on the substrate 302.

A sealing member (not shown) is formed on one of the substrates 302 and 304. Then, at least one drop of a liquid crystal material is formed on one of the substrates 302 and 304. One of the substrates 302 and 304 is superposed upon the other substrate. At last, a curing process of the sealing member is conducted thereby obtaining the liquid crystal display panel 400.

It should be noted that the protrusions 308 and 310 are preferably formed within the region covered by the light-shielding matrix to avoid adversely affecting the light-transmittance of the liquid crystal display device. The present invention is characterized by the provision of two groups of protrusions disposed on a substrate and the two groups of protrusions are separated from the opposing substrate by two difference distances. The aforementioned feature can be achieved by forming protrusions with the same height on different areas (with different protrusion height) of the lumpy surface of the color filter substrate 302 or the thin film transistor substrate 304, e.g., TFTs 318 v.s. other areas, thereby obtaining the protrusions 308 and 310 which have the same height but are separated from the substrate 302 by different distances (seed FIG. 3). Of course, the aforementioned feature can be achieved by two groups of protrusions with different height. Because the protrusions 308 and the protrusions 310 are separated from the substrate 304 by different distance, the liquid crystal display panel 300 or 400 has low-density spacers (i.e., the protrusions 308) when it is not subjected to an external force, and the liquid crystal display panel 300 or 400 has high-density spacers (i.e., protrusions 308 and 310) when it is subjected to an external force during subsequent LCD manufacturing process (e.g., laminating process or vacuum sucking process). Therefore, when an one drop fill process is used to manufacture the liquid crystal display panel, even though the liquid crystal injection quantity is less than the predetermined volume between the substrates, the protrusions 310 allow the external force to slightly bend the substrates such that the liquid crystal material can completely fill the curved cell and no void is observed thereby obtaining a larger process window in the liquid crystal injection process. However, when the liquid crystal display panel is subjected to an external force during the subsequent processes (e.g. laminating or vacuum sucking process) of the liquid crystal display device, not only the protrusions 308 but also the protrusions 310 can support the substrates of the liquid crystal display panel thereby preventing the liquid crystal display panel from being deformed too much that may cause Gravity mura or fracture. Namely, the liquid crystal display panel of the present invention has spacers with high density when it is subjected to an external force. Therefore, in the present invention, a larger process window in the liquid crystal injection process is achieved and the obtained liquid crystal display panel has a good mechanism strength.

Although the invention has been explained in relation to its preferred embodiment, it is to be understood that many other possible modifications and variations can be made without departing from the spirit and scope of the invention as hereinafter claimed.

What is claimed is:

1. A liquid crystal display panel, comprising:
a first substrate;
a second substrate;
a liquid crystal layer sandwiched between the first substrate and the second substrate;
a plurality of first protrusions disposed on the first substrate and separated from the second substrate by a first distance; and
a plurality of second protrusions disposed on the first substrate and separated from the second substrate by a second distance different from the first distance, wherein the difference between the second distance and the first distance is smaller than about 2.5 μm.

2. The liquid crystal display panel as claimed in claim 1, wherein the first protrusion is provided for maintaining a first cell gap between the first and second substrates.

3. The liquid crystal display panel as claimed in claim 2, wherein the second protrusion is provided for maintaining a second cell gap which is smaller than the first cell gap between the first and second substrates when the liquid crystal display panel is subjected to an external force.

4. The liquid crystal display panel as claimed in claim 1, wherein the first distance is different from the second distance by about 0.2 μm to about 2.5 μm, and the first distance approximates zero.

5. The liquid crystal display panel as claimed in claim 1, wherein the first protrusion and the second protrusion have a pillar shape.

6. The liquid crystal display panel as claimed in claim 1, further comprising a plurality of third protrusions disposed on one of the first and the second substrates for regulating orientation of the liquid crystal layer.

7. A liquid crystal display panel comprising:
a first substrate;
a second substrate;
a liquid crystal layer sandwiched between the first substrate and the second substrate;
a plurality of first protrusions disposed on the first substrate and separated from the second substrate by a first distance; and
a plurality of second protrusions disposed on the first substrate and separated from the second substrate by a second distance different from the first distance,
wherein the first protrusion and the second protrusion are made of a first material.

8. The liquid crystal display panel as claimed in claim 7, further comprising a plurality of third protrusions disposed on one of the first and the second substrates and made of a second material different from the first material.

9. The liquid crystal display panel as claimed in claim 8, wherein the first and second protrusions are harder than the third protrusion.

10. The liquid crystal display panel as claimed in claim 8, wherein the third protrusions are provided for regulating orientation of the liquid crystal layer.

11. The liquid crystal display panel as claimed in claim 7, wherein the first protrusion is provided for maintaining a first cell gap between the first and second substrates.

12. The liquid crystal display panel as claimed in claim 11, wherein the second protrusion is provided for maintaining a second cell gap which is smaller than the first cell gap between the first and second substrates when the liquid crystal display panel is subjected to an external force.

13. The liquid crystal display panel as claimed in claim 7, wherein the first distance approximates zero.

14. The liquid crystal display panel as claimed in claim 7, wherein the first protrusion and the second protrusion have a pillar shape.

15. A liquid crystal display panel comprising:
a first substrate;
a second substrate;
a liquid crystal layer sandwiched between the first substrate and the second substrate;
a plurality of first protrusions disposed on the first substrate and separated from the second substrate by a first distance;
a plurality of second protrusions disposed on the first substrate and separated from the second substrate by a second distance different from the first distance; and
a plurality of third protrusions disposed on one of the first and second substrates,
wherein, when the liquid crystal display panel is subjected to an external force, the first and the second protrusions contact the second substrate, but the third protrusions don't contact the other of the first and second substrates.

16. The liquid crystal display panel as claimed in claim 15, wherein the first protrusion is provided for maintaining a first cell gap between the first and second substrates.

17. The liquid crystal display panel as claimed in claim 16, wherein the second protrusion is provided for maintaining a second cell gap which is smaller than the first distance between the first and second substrates when the liquid crystal display panel is subjected to the external force.

18. The liquid crystal display panel as claimed in claim 15, wherein the first distance approximates zero.

19. The liquid crystal display panel as claimed in claim 15, wherein the first protrusion and the second protrusion have a pillar shape.

20. The liquid crystal display panel as claimed in claim 15, wherein the third protrusions are provided for regulating orientation of the liquid crystal layer.
